(19) United States
(12) Patent Application Publication
(10) Pub. No.: US 2007/0294468 A1
(43) Pub. Date: Dec. 20, 2007

(54) ARCHITECTURE FOR READING AND WRITING TO FLASH MEMORY

(76) Inventors: Aaron Olbrich, Morgan Hill, CA (US); Douglas A. Prius, Laguna Hills, CA (US)

Correspondence Address: BAKER BOTTS L.L.P., 2001 ROSS AVENUE, SUITE 600, DALLAS, TX, 75201-2980, US

(21) Appl. No.: 11/674,957

(22) Filed: Feb. 14, 2007

Related U.S. Application Data
(60) Provisional application No. 60/804,875, filed on Jun. 15, 2006.

(51) Int. Cl. G06F 12/00

(52) U.S. Cl. 711/103

(57) ABSTRACT

Apparatus for enabling access to Flash random access memory devices at substantially the same bandwidth and speed for both reading and writing. A plurality of processors can be dynamically and/or statically configured into separate portions to handle reading and writing actions. One portion can be arranged to separately handle interfacing with high speed connections to receive and respond to read and write commands from an external system. The second portion can be arranged to handle high speed access over an interface that can both read serially and write in parallel to the Flash random access memory device. By writing in parallel to the Flash random access memory device with multiple processors, the write mode is at least somewhat equivalent to or greater than the speed and bandwidth for a serial read of the memory device.

### RELATED APPLICATION

This patent application claims priority from Patent Application Ser. No. 60/804,875, filed Jun. 15, 2006, entitled ARCHITECTURE FOR READING AND WRITING TO FLASH MEMORY.

### TECHNICAL FIELD OF THE INVENTION

This application relates generally to the field of information storage, and more particularly to a method, system, and apparatus for enabling relatively equivalent throughput for reading and writing to solid state storage media.

### BACKGROUND OF THE INVENTION

The need for ever larger capacity data storage devices has become a constant theme in the rapid advance of computer technology. Today, the electromechanical disc drive is the most common data storage device in use that offers both relatively high storage capacity and relatively fast reading and writing of data. Although the amount of data that can be stored on such disc drives has increased dramatically in recent years, there are many applications that could benefit from a further decrease in the size, cost, and power consumption commonly associated with electromechanical disc drives.

Generally, disc drives are composed of one or more magnetic media discs attached to a spindle. A spindle motor rotates the spindle and the attached discs at a relatively constant high rate of speed, e.g., 10,000 rpm or higher. An actuator assembly adjacent to the disc(s) has actuator arms extending over the discs, each with one or more flexures extending from each actuator arm. A read/write head is mounted at the distal end of each of the flexures. The read/write head typically includes an air bearing slider enabling the head to “fly” in close proximity above the corresponding surface of the associated disc. Information is stored on and retrieved from a disc drive via the read/write head which recognizes each “bit” (a one or zero value) as a change or lack of change, respectively, in the orientation of adjacent magnetic domains on the disc surface. Recently, the physical limitations and power consumption characteristics of a disc drive's electromechanical components are becoming significant factors in preventing further reductions in cost, size, and power consumption.

Arrangements of integrated memory circuits (memory ICs) such as architectures for Flash random access memory (Flash RAM), can provide relatively high capacity alternatives to disc drives in a relatively smaller form factor with lower power consumption and cost. Unfortunately, although some architectures for accessing data stored in Flash RAM can enable relatively equivalent or faster reading than a disc drive, the ability to write information to the Flash RAM has often been a magnitude or more slower. Consequently, Flash RAM is most often used as a storage device for those applications where information is primarily read and occasionally written.

### SUMMARY OF THE INVENTION

The present invention is directed to an apparatus, system, method, and processor readable media for reading and writing information to a memory device. A first interface is provided for handling communication from an external system to the memory device for at least one of a read request and a write request. A memory is provided for enabling access to information and applications that manage the read and write requests from the external system. A second interface is provided for employing at least one of the read request and the write request to access at least one location in the memory device. Also, a buffer manager is in communication with the first interface, second interface, and memory to enable at least one of a plurality of processors to provide each read request in a serial format to the second interface and to provide each write request in a parallel format to the second interface. Additionally, the buffer manager enables at least another of the plurality of processors to enable communication by the first interface of a result for each request from the memory device to the external system.

In one embodiment, a portion of the plurality of processors are dynamically arranged to process each read request and each write request from the first interface for handling by the buffer manager. The dynamic arrangement of the plurality of processors is based at least in part on a type of the first interface, actual use, intended use, or load. In another embodiment, a portion of the plurality of processors are dynamically arranged to process each serial read request and each parallel write request provided from the buffer manager to the second interface. The dynamic arrangement of the plurality of processors is based at least in part on a type of the second interface, actual use, intended use, or load.

In still another embodiment, a general purpose host processor is provided for managing the operation of at least one of the buffer manager, memory, the plurality of processors, first interface, and second interface. In yet another embodiment, the memory device is a flash random access memory device and the first interface is a flash memory interface that enables communication with the flash random access memory device.

In yet still another embodiment, the first interface enables communication with the external system over at least one of Serial Advanced Technology Attachment (SATA), Serial Attached Small Computer Serial Interface (SAS), Firewire (IEEE 1394), or Universal Serial Bus (USB). In still yet another embodiment, the second interface enables communication with the memory device over at least one of Serial Advanced Technology Attachment (SATA), Serial Attached Small Computer Serial Interface (SAS), Firewire (IEEE 1394), or Universal Serial Bus (USB).

In another embodiment, the plurality of processors are at least one type that includes configurable long instruction word (CLIW), reduced instruction set computer (RISC), or complex instruction set computer (CISC). Additionally, in yet another embodiment, the invention is based on an electronic card that is relatively sized to the dimensions of a disc drive.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified. The drawings are not necessarily to scale, emphasis instead being placed upon illustrating the principles of the invention.

For a better understanding of the invention, reference will be made to the following Detailed Description of the Invention, which is to be read in association with the accompanying drawings, wherein:

FIG. 1 illustrates a block diagram of an architecture for enabling reads and writes of Flash memory devices;

FIG. 2 shows a block diagram of an integrated circuit that enables reads and writes of Flash memory devices;

FIG. 3 illustrates a block diagram of a computing device that includes a storage device that provides reading and writing capability to flash memory;

FIG. 4 shows a flow chart of a process for writing to a Flash memory device; and

FIG. 5 illustrates a flow chart of a process for reading to a Flash memory device, in accordance with the invention.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, an entirely software embodiment or an embodiment combining software and hardware aspects. The following detailed description is, therefore, not to be taken in a limiting sense.

Briefly stated, the invention is directed to an apparatus, method and system for enabling access to electronic memory devices, such as Flash RAM memory, at substantially the same bandwidth and speed for both the reading and writing modes of operation. The invention enables a writing mode to the memory device to operate at relatively equivalent or greater speeds and bandwidth than a reading mode, and where if not for the use of the invention, at least the speed of writing would be substantially less than the reading speed. The invention enables a plurality of processors to be dynamically and/or statically configured into two or more portions or groups. One portion is arranged to separately handle interfacing with high speed connections that receive and respond to read and write commands from a local or remote system. Another portion can be arranged to handle high speed access over an interface that can both read serially and write in parallel information to components of the memory device. By writing information in parallel to components of the memory device, the invention enables a write mode that is at least somewhat equivalent to the speed and bandwidth for a serial read of information stored in the memory device's components.

A buffer manager application is provided for at least managing the operation and/or arrangement of at least a portion of a plurality of processors that enable the reading and writing of information from/to the memory device. The buffer manager can also be arranged to manage at least a portion of a plurality of processors that enable the receiving and responding to requests for information from a system over a high speed interface. A host processor can be provided for managing other tasks that support and are relatively different than reading and writing to the memory. Additionally, some or all of the multiple processors, the host processor, the high speed memory interface, and the high speed system interface can be included in one application specific integrated circuit (ASIC), and the like.

In one embodiment, the plurality of processors can include one or more types of processors, including, but not limited to, configurable long instruction word (CLIW), reduced instruction set computer (RISC), complex instruction set computer (CISC), and the like. Also, the host processor may be enabled with a relatively general purpose processor core, e.g., a processor core such as those that are licensable from the ARM corporation, and the like.

In one or more embodiments, for receiving and responding to system interface requests, one or more high speed data communication interfaces may be employed, e.g., Serial Advanced Technology Attachment (SATA), Serial Attached Small Computer Serial Interface (SAS), Firewire (IEEE 1394), Universal Serial Bus (USB), and the like. Similarly, one or more high speed data communication interfaces may be provided for reading and writing information to memory devices, including, but not limited to, SATA, SAS, Firewire, and USB.

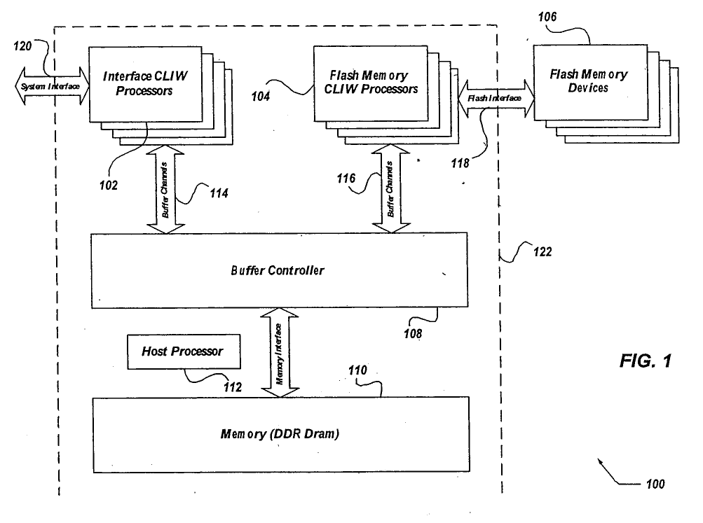

FIG. 1 shows a block diagram of architecture 100 for enabling writing to flash memory devices at speeds that are substantially equivalent or greater than reading with integrated circuit 122. Integrated circuit 122 includes a plurality of CLIW processors 102 that can be statically and/or dynamically arranged by at least buffer manager 108 to support requests for information and responses/results for a remotely located (or local) system over high speed interface 120. Processors 102 are also arranged to be in communication with buffer manager 108 over one or more buffer channels 114. Additionally, multiple CLIW processors 104 can be statically and/or dynamically arranged by buffer manager 108 to read and write to a plurality of Flash memory devices 106 over Flash interface 118. Processors 104 are further arranged to be in communication with buffer manager 108 over one or more buffer channels 116. Processors 104 enable serial reads from Flash memory devices 106 and substantially parallel writes to the Flash memory devices.

Buffer manager 108 can enable an application stored in memory 110 that is configured to statically and/or dynamically arrange and manage the communication and operation of the plurality of processors 102, 104 for system interface 120 and Flash memory interface 118. This static and/or dynamic arrangement of processors can be based on different factors, such as type of system and memory interfaces, actual use, intended use, load, and the like. Buffer manager 108 is also in communication with memory 110 and host processor 112. Host processor 112 is arranged to enable other functionality that generally supports the reading and writing of information to the Flash memory devices and requests and responses to a system. In different embodiments, the dynamic arrangement of the plurality of processors can be managed by the buffer manager, an application, and discrete logic, either singly, or in any combination.

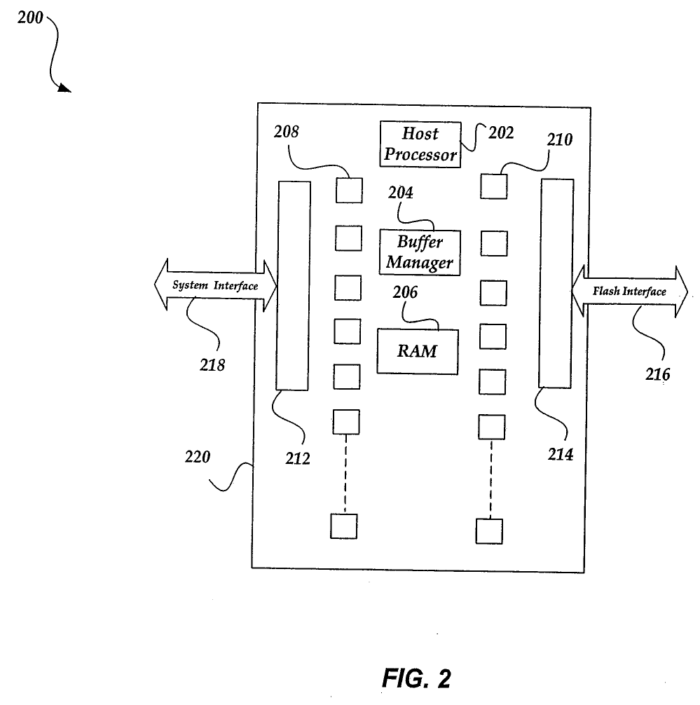

FIG. 2 illustrates an exemplary overview of an electronic card 200 with an integrated circuit 220 which includes host processor 202, buffer manager 204, and Read and Write Memory (RAM) 206. Integrated circuit 220 also includes a group of processors 208 that are arranged for receiving requests for information and providing responses. Module 212 is arranged to communicate requests and responses over system interface 218 to an external and/or local system. Another group of processors 210 are arranged for reading serially and writing in parallel to a Flash memory device. Module 214 is arranged to communicate reads and writes over Flash memory interface 216. Although not shown, in one embodiment, the electronic card can include the Flash memory device. Also, electronic card 200 can be sized to relatively the same dimensions of a disc drive to facilitate installation in virtually any system that employs disc drives, such as personal computers, notebook computers, server computers, media players, mobile devices, and the like.

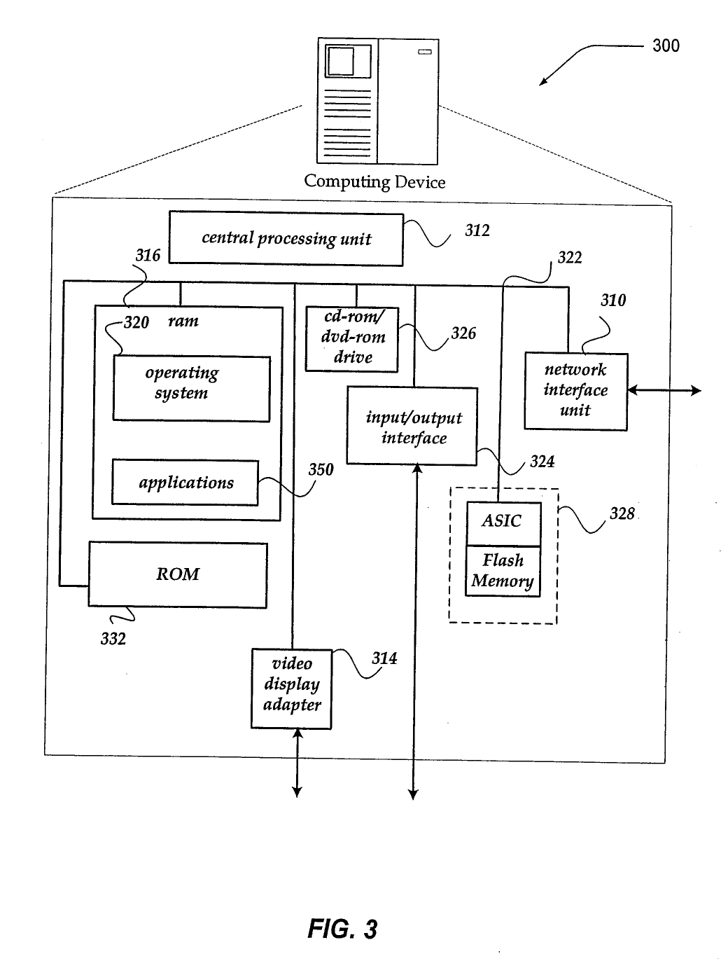

FIG. 3 shows computing device 300 which is in accordance with at least one embodiment of the invention. Computing device 300 may include many more or less components than those shown. The components shown, however, are sufficient to disclose an illustrative embodiment for practicing the invention. Also, in one or more embodiments, computing device 300 may be employed in different ways, including, but not limited to a mobile device, personal computer, notebook computer, server computer, network appliance, personal digital assistant (PDA), media player and/or recorder, camera, and the like.

Computing device 300 includes processing unit 312, video display adapter 314, and a mass memory, all in communication with each other via bus 322. The mass memory generally includes RAM 316, ROM 332, and one or more mass storage devices, such as CD-ROM/DVD-ROM drive 326. The mass memory stores operating system 320 for controlling the operation of computing device 300. Operating system 320 may further include networking components.

As illustrated in FIG. 3, computing device 300 also can communicate with the Internet, or some other communications network, via network interface unit 310, which is constructed for use with various communication protocols including the TCP/IP protocol. Network interface unit 310 is sometimes known as a transceiver, transceiving device, network interface card (NIC), and the like. Additionally, computing device 300 may include input/output interface 324 for communicating with external devices, such as a mouse, keyboard, scanner, or other input devices (not shown).

The mass memory as described above illustrates another type of processor readable media, such as storage media. Storage media may include volatile, nonvolatile, removable, and non-removable processor readable media implemented in any method or technology for storage of information, such as processor readable instructions, data structures, modules, components, data, and the like. Examples of processor readable media include RAM, ROM, EEPROM, flash memory or other memory technology, CD-ROM, digital versatile disks (DVD) or other optical storage media, magnetic tape cassettes, magnetic tape, magnetic disk storage (floppy disk) or other magnetic storage devices, or any other medium which can be used to store information and which can be accessed by a computing device. The mass memory also stores program code and data. One or more applications 350 are loaded into mass memory and run on operating system 320. Examples of application programs may include email programs, routing programs, editors, schedulers, calendars, database programs, word processing programs, HTTP programs, traffic management programs, security programs, and so forth.

Computing device 300 includes solid state memory device 328 which further includes at least one Application Specific Integrated Circuit (ASIC) chip and a Flash memory device coupled to bus 322. The ASIC can include logic and/or processors that enable solid state memory device 328 to emulate the performance of another type of mass storage media, such as an electromechanical disc drive. The ASIC can be arranged to enable reads and writes to the Flash Memory device in response to requests. Also, the ASIC may be utilized to access the Flash Memory device for, among other things, applications, programs, modules, components, databases, and the like.

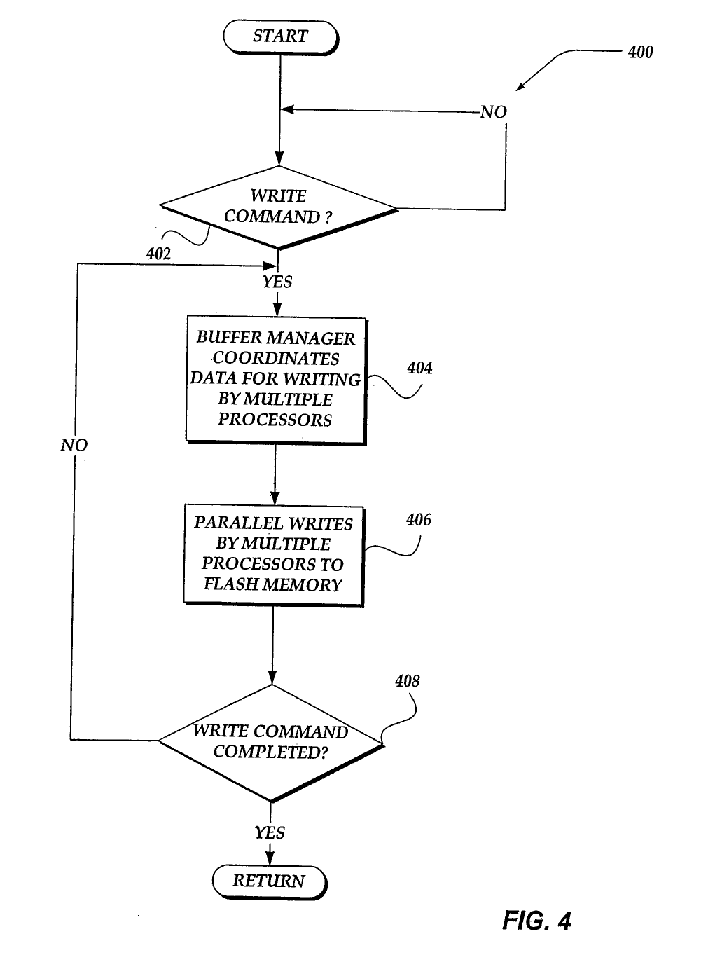

FIG. 4 illustrates a flow chart of an inventive process for an exemplary write to Flash memory devices. Moving from a start block, the process steps to decision block 402 where a determination is made as to whether or not a request for a write to a Flash memory has occurred. If negative, the process repeats the determination. However, once the determination is affirmative, the process flows to block 404 where the buffer manager application manages the arrangement of at least a portion of a plurality of processors to receive data that is to be written to the Flash memory devices. In one embodiment, the arrangement of the portion (number) of the processors is static, i.e., a fixed number of the processors are prearranged to receive data to be written to the Flash memory devices. In another embodiment, the portion of the plurality of processors is dynamically arranged based at least in part on based on different factors, such as type of system interface, actual use, intended use, load, and the like. In yet another embodiment, some of the plurality of processors are statically prearranged and others of the plurality of processors are dynamically arranged.

At block 406, the buffer manager arranges a portion of the plurality of processors to write the data in parallel to a plurality of Flash memory devices. In one embodiment, the arrangement of the portion (number) of the processors is static, i.e., a fixed number of the processors are prearranged to write data in parallel to the plurality of Flash memory devices. In another embodiment, the portion of the plurality of processors is dynamically arranged based at least in part on based on different factors, such as type of memory interface, actual use, intended use, load, and the like. In yet another embodiment, some of the plurality of processors are statically prearranged and others of the plurality of processors are dynamically arranged. In different embodiments, the dynamic arrangement of the plurality of processors can be managed by the buffer manager, an application, and discrete logic, either singly, or in any combination.

Next, the process flows to block 408, where another determination is made as to whether the writing to the Flash memory devices is completed. If not, the process loops back to block 404 and performs substantially the same actions as discussed above. However, if the determination at decision block 408 is true, the process returns to performing other actions.

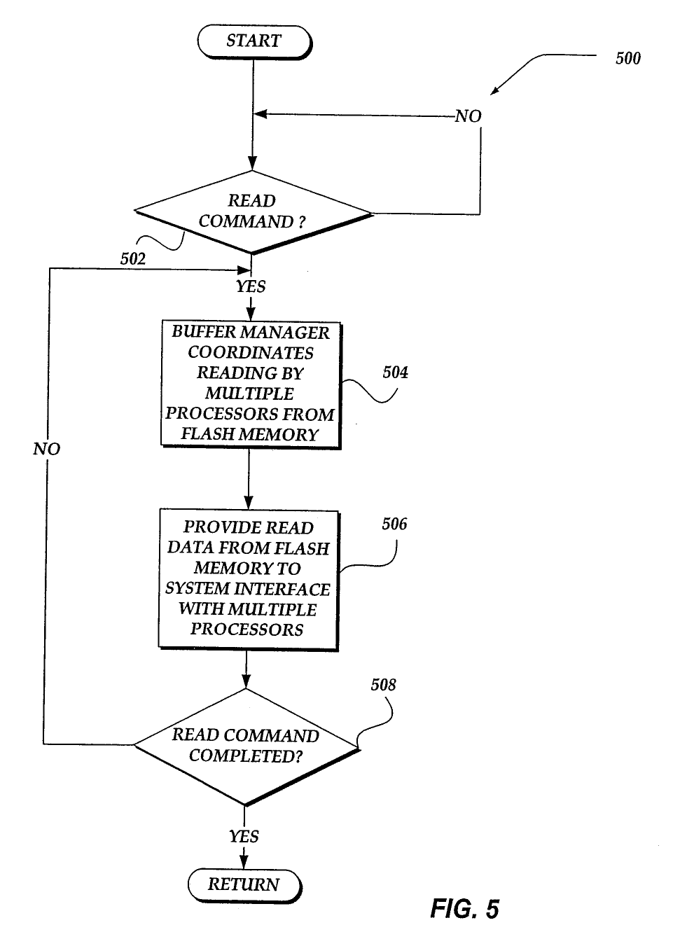

FIG. 5 illustrates a flow chart of an inventive process for an exemplary read of data stored on Flash memory devices. Moving from a start block, the process steps to decision block 502 where a determination is made as to whether or not a request for a Flash memory read request from an external system communicating over a system interface has occurred. If negative, the process repeats the determination. However, once the determination is affirmative, the process flows to block 504 where the buffer manager application coordinates the arrangement of a portion of a plurality of processors to receive data that is serially read from the Flash memory devices. In one embodiment, the arrangement of the portion (number) of the processors is static, i.e., a fixed number of the processors are prearranged to serially read data from the Flash memory devices. In another embodiment, the portion of the plurality of processors is dynamically arranged based at least in part on based on different factors, such as type of memory interface, actual use, intended use, load, and the like. In yet another embodiment, some of the plurality of processors are statically prearranged and others of the plurality of processors are dynamically arranged. In different embodiments, the dynamic arrangement of the plurality of processors can be managed by the buffer manager, an application, and discrete logic, either singly, or in any combination.

At block 506, the buffer manager arranges a portion of the plurality of processors to provide the “read” data over the system interface to an external system. In one embodiment, the arrangement of the portion (number) of the processors is static, i.e., a fixed number of the processors are prearranged to provide the read data to the system interface. In another embodiment, the portion of the plurality of processors are dynamically arranged based at least in part on different factors, such as type of system interface, actual use, intended use, load, and the like. In yet another embodiment, some of the plurality of processors are statically prearranged and others of the plurality of processors are dynamically arranged.

Next, the process flows to block 508, where another determination is made as to whether the reading from the Flash memory devices is completed. If not, the process loops back to block 504 and performs substantially the same actions as discussed above. However, if the determination at decision block 508 is true, the process returns to performing other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. An apparatus for reading and writing information to a memory device, comprising:
a first interface for handling communication from an external system to the memory device for at least one of a read request and a write request;
a memory for enabling access to information for handling the read and write requests from the external system;
a second interface for employing at least one of the read request and the write request to access at least one location in the memory device; and
a buffer manager in communication with the first interface, second interface, and memory, wherein the buffer manager enables at least one of a plurality of processors to provide each read request in a serial format to the second interface and to provide each write request in a parallel format to the second interface, and wherein the buffer manager enables at least another of the plurality of processors to enable communication by the first interface of a result for each request from the memory device to the external system.

2. The apparatus of claim 1, further comprising a portion of the plurality of processors that are dynamically arranged to process each read request and each write request from the first interface for handling by the buffer manager, wherein the dynamic arrangement of the plurality of processors is based at least in part on a type of the first interface, actual use, intended use, or load.

3. The apparatus of claim 1, further comprising a portion of the plurality of processors that are dynamically arranged to process each serial read request and each parallel write request provided from the buffer manager to the second interface, wherein the dynamic arrangement of the plurality of processors is based at least in part on a type of the second interface, actual use, intended use, or load.

4. The apparatus of claim 1, further comprising a general purpose host processor for managing the operation of at least one of the buffer manager, memory, the plurality of processors, first interface, and second interface.

5. The apparatus of claim 1, wherein the memory device is a flash random access memory device, and wherein the first interface is a flash memory interface that enables communication with the flash random access memory device.

6. The apparatus of claim 1, wherein the first interface enables communication with the external system over at least one of Serial Advanced Technology Attachment (SATA), Serial Attached Small Computer Serial Interface (SAS), Firewire (IEEE 1394), or Universal Serial Bus (USB).

7. The apparatus of claim 1, wherein the second interface enables communication with the memory device over at least one of Serial Advanced Technology Attachment (SATA), Serial Attached Small Computer Serial Interface (SAS), Firewire (IEEE 1394), or Universal Serial Bus (USB).

8. The apparatus of claim 1, wherein the plurality of processors are at least one type that includes configurable long instruction word (CLIW), reduced instruction set computer (RISC), or complex instruction set computer (CISC).

9. The apparatus of claim 1, wherein the apparatus is based on an electronic card that is relatively sized to the dimensions of a disc drive.

10. A system for reading and writing information, comprising:
a memory device;
a first interface for handling communication from an external system to the memory device for at least one of a read request and a write request;
a memory for enabling access to information for handling the read and write requests from the external system;
a second interface for employing at least one of the read request and the write request to access at least one location in the memory device; and
a buffer manager in communication with the first interface, second interface, and memory, wherein the buffer manager enables at least one of a plurality of processors to provide each read request in a processed serial format to the second interface and to provide each write request in a processed parallel format to the second interface, and wherein the buffer manager enables at least another of the plurality of processors to enable communication by the first interface of a result for each request from the memory device to the external system.

11. The system of claim 10, further comprising a portion of the plurality of processors that are dynamically arranged to process each read request and each write request from the first interface for handling by the buffer manager, wherein the dynamic arrangement of the plurality of processors is based at least in part on a type of the first interface, actual use, intended use, or load.

12. The system of claim 10, further comprising a portion of the plurality of processors that are dynamically arranged to process each serial read request and each parallel write request provided from the buffer manager to the second interface, wherein the dynamic arrangement of the plurality of processors is based at least in part on a type of the second interface, actual use, intended use, or load.

13. The system of claim 10, wherein the memory device is a flash random access memory device, and wherein the first interface is a flash memory interface that enables communication with the flash random access memory device.

14. The system of claim 1, wherein the plurality of processors are at least one type that includes configurable long instruction word (CLIW), reduced instruction set computer (RISC), or complex instruction set computer (CISC).

15. A method for reading and writing information to a memory device, comprising:
processing communication from an external system to the memory device for at least one of a read request and a write request;
employing at least one of the read request and the write request to access at least one location in the memory device;
dynamically allocating at least a portion of a plurality of resources to process each read request and each write request;
providing each read request in a processed serial format to the memory device and providing each write request in a processed parallel format to the memory device; and
communicating a result from the memory device to the external system for each read request and each write request.

16. The method of claim 15, further comprising dynamically arranging at least a portion of a plurality of processor based resources to process each read request and each write request, wherein the dynamic arrangement of the plurality of processor resources is based at least in part on actual use, intended use, or load.

17. The method of claim 15, further comprising dynamically arranging at least a portion of a plurality of processor based resources to process each serial read request and each parallel write request, wherein the dynamic arrangement of the plurality of processor resources is based at least in part on actual use, intended use, or load.

18. A processor readable media that includes a plurality of modules for reading and writing information with a memory device, comprising:
a first module for processing communication from an external system to the memory device for at least one of a read request and a write request;
a second module for employing at least one of the read request and the write request to access at least one location in the memory device;
a third module for dynamically allocating resources to process each read request and each write request;
a fourth module for providing each read request in a processed serial format to the memory device and providing each write request in a processed parallel format to the memory device; and
a fifth module for communicating a result from the memory device to the external system for each read request and each write request.

19. The processor readable media of claim 18, further comprising dynamically arranging at least a portion of a plurality of processor based resources to process each read request and each write request, wherein the dynamic arrangement of the plurality of processor resources is based at least in part on actual use, intended use, or load.

20. The processor readable media of claim 18, further comprising dynamically arranging at least a portion of a plurality of processor based resources to process each serial read request and each parallel write request, wherein the dynamic arrangement of the plurality of processor resources is based at least in part on actual use, intended use, or load.
